(19) United States
(12) Patent Application Publication
(10) Pub. No.: US 2014/0181641 A1
(43) Pub. Date: Jun. 26, 2014

(54) SERVER AND METHOD FOR LOADING WEB PAGES

(71) Applicants: HON HAI PRECISION INDUSTRY CO., LTD., NEW TAIPEI (TW); HONG FU JIN PRECISION INDUSTRY (SHENZHEN) CO., LTD ., SHENZHEN (CN)

(72) Inventors: CHUNG-I LEE, New Taipei (TW); DE-YI XIE, Shenzhen (CN); MI-HUA ZHAO, Shenzhen (CN)

(73) Assignees: HON HAI PRECISION INDUSTRY CO., LTD., NEW TAIPEI (TW); HONG FU JIN PRECISION INDUSTRY (SHENZHEN) CO., LTD ., SHENZHEN (CN)

(21) Appl. No.: 14/133,718

(22) Filed: Dec. 19, 2013

(30) Foreign Application Priority Data
Dec. 21, 2012 (CN) 2012105596924

(51) Int. Cl. G06F 17/22; H04L 29/08

(52) U.S. Cl. CPC G06F 17/2247; H04L 67/02
USPC 715/234

(57) ABSTRACT

In a method for loading web pages, a time interval of how often data is retrieved from a database is set. When a user accesses a web page from a web server, one screen of data of the web page is retrieved from the database and displayed on a display device. Then one screen of remaining data of the web page is retrieved from the database every time interval until all of the remaining data has been retrieved, and all of the retrieved data is stored in a file. A next screen of data of the web page is loaded from the file and displayed on the display device until all of the data in the file has been loaded, in response that a vertical scroll bar displayed on the web page reaches a preset position.

### BACKGROUND

1. Technical Field

Embodiments of the present disclosure generally relate to data processing technology, and particularly to a server and a method for loading web pages.

2. Description of Related Art

A web page may contain a large amount of data. Reading the large amount of data from a database at one time may consume a lot of time. Furthermore, to display the large amount of data at one time with a browser may cause a heavy burden to the browser. Therefore, there is room for improvement in the art.

### BRIEF DESCRIPTION OF THE DRAWINGS

FIG. 1 is a block diagram of one embodiment of a web server including a management unit.

FIG. 2 is a block diagram of one embodiment of function modules of the management unit in FIG. 1.

FIG. 3 is a flowchart of one embodiment of a method for loading web pages.

FIG. 4 is a schematic diagram of one embodiment of a web page.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

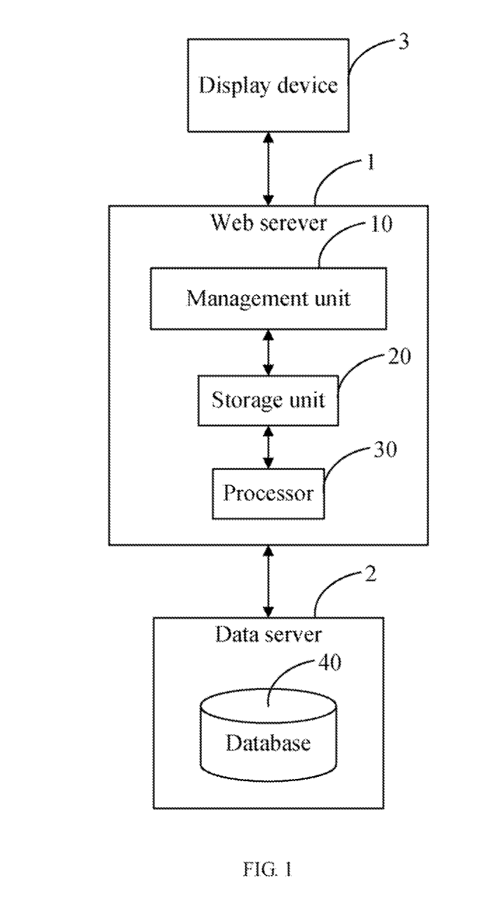

FIG. 1 is a block diagram of one embodiment of a web server 1. In the embodiment, the web server 1 includes a management unit 10, a storage unit 20, and a processor 30. The web server 1 is electronically connected to a data server 2 and a display device 3. The data server 2 includes a database 40, which stores data of web pages. In other embodiments, the data server 2 may be merged with the web server 1.

The management unit 10 reads data (e.g., text, HTML, CSS) of a web page from the database 40 at a specified time interval, and stores all of the read data in a file. When a user accesses the web page from the web server 1, the management unit 10 loads and displays one screen of data of the web page on the display device 3 at one time. In the embodiment, one screen of data is defined as the amount of visual data the screen of the display device 3 can display at one time according to a current resolution of the display device 3. For example, if the screen of the display device 3 is currently displaying 250 words, then 250 words can represent one screen of data.

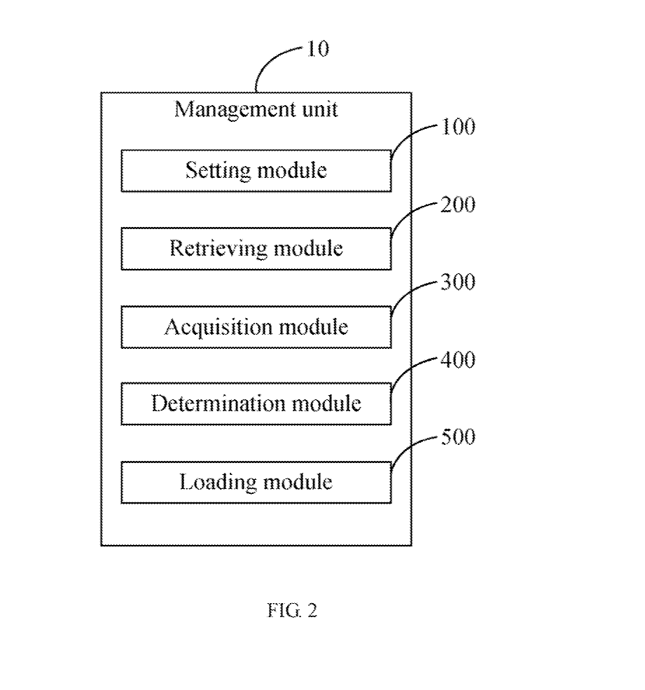

In one embodiment, the management unit 10 may include one or more function modules (as shown in FIG. 2). The one or more function modules may include computerized code in the form of one or more programs that are stored in the storage unit 20, and executed by the processor 30 to provide the functions of the management unit 10. The storage unit 20 may be a dedicated memory, such as an EPROM or a flash memory.

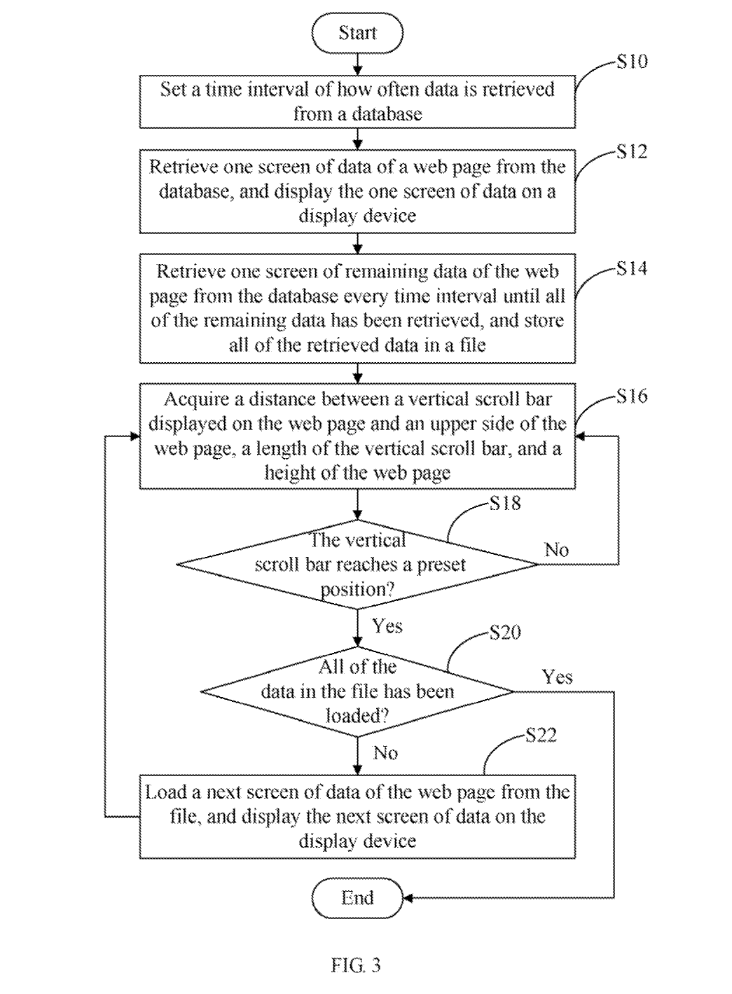

FIG. 2 is a block diagram of one embodiment of the function modules of the management unit 10. In one embodiment, the management unit 10 includes a setting module 100, a retrieving module 200, an acquisition module 300, a determination module 400, and a loading module 500. A description of the functions of the modules 100-500 is given with reference to FIG. 3.

FIG. 3 is a flowchart of one embodiment of a method for loading web pages from the data server 2 to the display device 3. Depending on the embodiment, additional steps may be added, others removed, and the ordering of the steps may be changed, all steps are labeled with even numbers only.

In step S10, the setting module 100 sets a time interval of how often data is retrieved from the database 40. For example, in the embodiment, the time interval is two minutes.

In step S12, when a user accesses a web page from the web server 1, the retrieving module 200 retrieves one screen of data of the web page from the database 40, and displays the one screen of data on the display device 3.

In step S14, the retrieving module 200 retrieves one screen of remaining data of the web page from the database 40 every time interval until all of the remaining data has been retrieved, and stores all of the retrieved data in a file (e.g., a XML file). The remaining data is data of the web page in the database 40 that has not been retrieved from the database 40 to the display device 3. The file is stored in the storage unit 20. In the embodiment, the retrieving module 200 may set a first tag in the database 40 to mark the retrieved data. For example, after retrieving one screen of data from the database 40, the retrieving module 200 sets a first tag T₁ at the end of the one screen of data in the database 40. After retrieving a next screen of data from the database 40, the retrieving module 200 moves the first tag T₁ to the end of the next screen of data in the database 40.

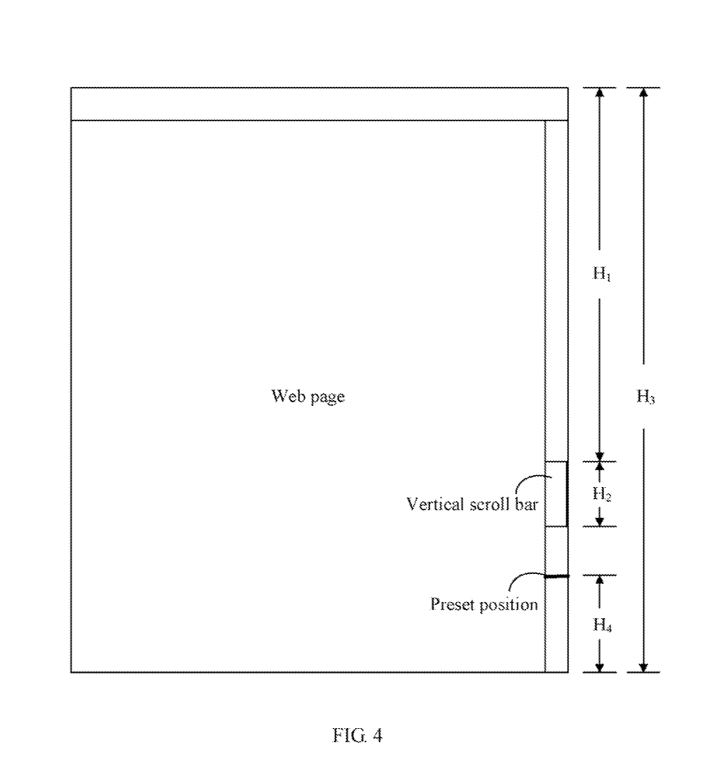

In step S16, the acquisition module 300 acquires a distance between a vertical scroll bar displayed on the web page (e.g., on a right side of the web page as shown in FIG. 4) and an upper side of the web page, a length of the vertical scroll bar, and a height of the web page. For example, as shown in FIG. 4, the distance between the vertical scroll bar displayed on the right side the web page and the upper side of the web page is H₁, the length of the vertical scroll bar is H₂, and the height of the web page is H₃.

In step S18, the determination module 400 determines whether the vertical scroll bar displayed on the web page reaches a preset position on the web page. In the embodiment, a distance between the preset position and a bottom side of the web page is H₄ (H₄≧0). If H₁+H₂=H₃−H₄, the determination module 400 determines that the vertical scroll bar reaches the preset position, then step S20 is implemented. If H₁+H₂<H₃−H₄ (as shown in FIG. 4), the determination module 400 determines that the vertical scroll bar does not reach the preset position, then the procedure returns to step S16.

In step S20, the determination module 400 determines whether all of the data in the file has been loaded to the display device 3. In the embodiment, the loading module 500 may set a second tag in the file to mark the loaded data. For example, after loading one screen of data from the file to the display device 3, the loading module 500 sets a second tag T₂ at the end of the one screen of data in the file. After loading a next screen of data from the file to the display device 3, the loading module 500 moves the second tag T₂ to the end of the next screen of data in the file. If there is data which has not been loaded from the file to the display device 3, step S22 is implemented. If all of the data in the file has been loaded to the display device 3, the procedure ends.

In step S22, the loading module 500 loads a next screen of data of the web page from the file, and displays the next screen of data on the display device 3. Then the procedure returns to step S16.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of a server, the server being electronically connected to a display device, the method comprising:
(a) setting a time interval of how often data is retrieved from a database;
(b) retrieving one screen of data of a web page from the database, and displaying the one screen of data on the display device;
(c) retrieving one screen of remaining data of the web page from the database every time interval until all of the remaining data has been retrieved, and storing all of the retrieved data in a file; and
(d) loading a next screen of data of the web page from the file, and displaying the next screen of data on the display device until all of the data in the file has been loaded to the display device, in response that a vertical scroll bar displayed on the web page reaches a preset position.

2. The method as claimed in claim 1, wherein a first tag is set in the database to mark the data retrieved from the database to the file.

3. The method as claimed in claim 1, wherein a second tag is set in the file to mark the data loaded from the file to the display device.

4. The method as claimed in claim 1, wherein between step (c) and step (d), the method further comprises:
acquiring a distance between the vertical scroll bar displayed on the web page and an upper side of the web page, a length of the vertical scroll bar, and a height of the web page; and
determining whether the vertical scroll bar reaches the preset position on the web page according to the distance, the length, and the height.

5. The method as claimed in claim 4, wherein:
the distance between the vertical scroll bar and the upper side of the web page is H₁, the length of the vertical scroll bar is H₂, the height of the web page is H₃, and a distance between the preset position and a bottom side of the web page is H₄;
the vertical scroll bar is determined as reaching the preset position in response that H₁+H₂=H₃−H₄; and
the vertical scroll bar is determined as not reaching the preset position in response that H₁+H₂<H₃−H₄.

6. A non-transitory storage medium storing a set of instructions, the set of instructions being executed by a processor of a server electronically connected to a display device, to perform a method comprising:
(a) setting a time interval of how often data is retrieved from a database;
(b) retrieving one screen of data of a web page from the database, and displaying the one screen of data on the display device;
(c) retrieving one screen of remaining data of the web page from the database every time interval until all of the remaining data has been retrieved, and storing all of the retrieved data in a file; and
(d) loading a next screen of data of the web page from the file, and displaying the next screen of data on the display device until all of the data in the file has been loaded to the display device, in response that a vertical scroll bar displayed on the web page reaches a preset position.

7. The non-transitory storage medium as claimed in claim 6, wherein a first tag is set in the database to mark the data retrieved from the database to the file.

8. The non-transitory storage medium as claimed in claim 6, wherein a second tag is set in the file to mark the data loaded from the file to the display device.

9. The non-transitory storage medium as claimed in claim 6, wherein between step (c) and step (d), the method further comprises:
acquiring a distance between the vertical scroll bar displayed on the web page and an upper side of the web page, a length of the vertical scroll bar, and a height of the web page; and
determining whether the vertical scroll bar reaches the preset position on the web page according to the distance, the length, and the height.

10. The non-transitory storage medium as claimed in claim 9, wherein:
the distance between the vertical scroll bar and the upper side of the web page is H₁, the length of the vertical scroll bar is H₂, the height of the web page is H₃, and a distance between the preset position and a bottom side of the web page is H₄;
the vertical scroll bar is determined as reaching the preset position in response that H₁+H₂=H₃−H₄; and
the vertical scroll bar is determined as not reaching the preset position in response that H₁+H₂<H₃−H₄.

11. A server electronically connected to a display device, the server comprising:
at least one processor; and
a storage unit storing one or more programs, which when executed by the at least one processor, causes the at least one processor to:
set a time interval of how often data is retrieved from a database;
retrieve one screen of data of a web page from the database, and display the one screen of data on the display device;
retrieve one screen of remaining data of the web page from the database every time interval until all of the remaining data has been retrieved, and store all of the retrieved data in a file; and
load a next screen of data of the web page from the file, and display the next screen of data on the display device until all of the data in the file has been loaded to the display device, in response that a vertical scroll bar displayed on the web page reaches a preset position.

12. The server as claimed in claim 11, wherein a first tag is set in the database to mark the data retrieved from the database to the file.

13. The server as claimed in claim 11, wherein a second tag is set in the file to mark the data loaded from the file to the display device.

14. The server as claimed in claim 11, wherein the one or more programs further causes the at least one processor to:
acquire a distance between the vertical scroll bar displayed on the web page and an upper side of the web page, a length of the vertical scroll bar, and a height of the web page; and
determine whether the vertical scroll bar reaches the preset position on the web page according to the distance, the length, and the height.

15. The server as claimed in claim 14, wherein:
the distance between the vertical scroll bar and the upper side of the web page is H₁, the length of the vertical scroll bar is H₂, the height of the web page is H₃, and a distance between the preset position and a bottom side of the web page is H₄;
the vertical scroll bar is determined as reaching the preset position in response that H₁+H₂=H₃−H₄; and
the vertical scroll bar is determined as not reaching the preset position in response that H₁+H₂<H₃−H₄.
